(19) United States
(12) Patent Application Publication
(10) Pub. No.: US 2003/0103607 A1
(43) Pub. Date: Jun. 5, 2003

(54) System and method for providing an internet audio stream to a wap mobile telephone

(76) Inventor: Kieren Feakes, Surrrey (GB)

Correspondence Address: Flynn Thiel Boutell & Tanis, 2026 Rambling Road, Kalamazoo, MI, 49008-1699, US

(21) Appl. No.: 10/240,609

(22) PCT Filed: Apr. 4, 2001
(86) PCT No.: PCT/GB01/01547

(30) Foreign Application Priority Data
Apr. 5, 2000 (GB) 0008383.2

(51) Int. Cl. H04M 1/64

(52) U.S. Cl. 379/88.17

(57) ABSTRACT

The user of a mobile telephone (10) interacts with an Internet server (22) using the browsing capability of the mobile telephone. If the user requests a real-time audio streaming service, the audio is delivered to the end user through the telephone system (12) using the voice telephony capability of the mobile telephone. For this, the mobile telephone (10) receives instructions which tell it to automatically make a telephone call to an assigned telephone number which is allocated to an audio gateway (28). The gateway is linked to the internet (20) and receives the internet audio, which it converts into a form suitable for interfacing to the telephony network. A pool of telephone numbers is allocated to the gateway (28). When an audio service is requested, a temporary association is made between an unassigned number in the pool and the requested service. The mobile telephone is then instructed to dial this newly associated number in order to connect the user to the requested service. A string of digits may be added to the assigned telephone number to act as a password.

### BACKGROUND OF THE INVENTION

This invention relates to a system and a method for providing, from a data network such as the internet, audio in the form of a real-time audio stream to a telephone terminal, particularly a mobile telephone capable of running the WAP (wireless application protocol) or similar browsing application software.

In this specification the expression “telephone terminal” is intended to include devices which have a telephone function in addition to other functions.

Primarily, internet access is achieved from a personal computer (PC) equipped with a modem and software known as a browser. Connection is made through the public fixed telephone network with a gateway provided by an internet service provider (ISP). The PC is equipped with an expansion card (a sound card) which provides audio output to a pair of loudspeakers. In order to hear real-time audio, the user loads special audio software onto the computer, usually by downloading from the internet. Examples of such software are RealPlayer available from Real Networks Inc., Seattle, USA, and Microsoft Windows MediaPlayer available from Microsoft Corporation. When the browser detects that an audio stream is being received, it launches the audio software, which interprets the codes received over the internet so that the sound card can reproduce the sound via the loudspeakers.

Mobile telephones have enhanced capabilities and can be used for purposes other than just making conventional voice calls. For example they can be used for text messages using the so-called short message service (SMS).

It is also now possible to use a mobile telephone to receive textual and graphical content from the internet (or any similar data network). To achieve this the telephone makes use of the wireless application protocol (WAP), or HDML (Handheld Devices Markup Language), a mobile-specific variant of HTML (HyperText Markup Language). The WAP is a de facto world standard, and HDML/HTML are standardised sub-sets of SGML (standard generalised markup language).

There is a problem, however, if the user wishes to receive a real-time audio stream on his mobile telephone. The WAP standard does not provide the full facilities that a browser running on a PC provides, and in particular does not provide for the receipt of a real-time audio stream.

The following prior documents are of interest and form part of the background art in relation to the present invention: U.S. Pat. Nos. 5,113,430, 5,860,068 and 5,963,916; European Patent Applications 0843454 and 0845894; United Kingdom Patent Application 2336505; International Patent Applications Publication Numbers 97/13352, 98/47252, 98/41003 and 99/27697

### SUMMARY OF THE INVENTION

The invention in its various aspects is defined in the independent claims below, to which reference should now be made. Advantageous features of the invention are set forth in the appendant claims.

A preferred system and method embodying the invention are described in more detail below with reference to the drawings. In the preferred system, the user of a mobile telephone interacts with an internet server (or other remote service) using the browsing capability of the mobile telephone. If the user requests or requires a real-time audio streaming service, then the audio is delivered to the end user not through the internet features of the telephone, but rather through the telephone system using the voice telephony capability of the mobile telephone.

In outline, the way this is achieved in the preferred system is as follows. When real-time audio is requested, the mobile telephone receives instructions which tell it to automatically make a telephone call to an assigned telephone number, which is one of many numbers allocated to a voice or audio gateway. The voice gateway is linked to the internet and receives the internet audio, which it converts into a form suitable for interfacing to the telephony network.

A pool of telephone numbers is allocated to and available at the voice gateway. When an audio service is requested, a connection or association is made between an unassigned number in the pool and the requested service. The mobile telephone is then instructed to dial this newly associated number in order to connect the user to the requested service. The number is assigned only temporarily; when that specific user has finished his or her connection to that specific service, the assignment is terminated and the number is returned to the pool.

The temporary assignment of numbers in this way gets over the problem that the number of remote services which are available to be requested is so enormous that it is not practically possible to allocate a unique telephone number to each of the possible services in the normal manner. By using the temporary assignment method described, a potentially infinite number of services can be made available.

It is important that the call made to the gateway is verified as a properly authorised call. If this were not the case, an unauthorised third party randomly dialling numbers might call one of the assigned numbers and receive a service requested, and possibly paid for, by an authorised user. To overcome this problem, the preferred system adds a string of digits to the assigned telephone number. This string acts as a password. It is included in the instruction to the mobile telephone to make the call. The receiving voice gateway extracts the appended string of digits from the called number and validates them. For this purpose it receives the string directly from the authenticator via standard telephony signalling. The string of digits are standard telephony digits used for dialling.

During the call the user may wish to control certain aspects of the audio stream transport. Such aspects may include features analogous to those found on a tape player or CD (compact disc) player, including for example fast forward, rewind, pause, and skip to next item. As the telephone is now in a voice call, the browser capability may not be available and consequently cannot be used to remotely operate the transport controls. In accordance with the preferred system, the user makes use of the number keys on the telephone keypad, and the dual-tone multi-frequency (DTMF) tones thus generated are detected by the voice gateway and then sent as control messages to the audio source (the audio server). The relationship between the digits of the keypad and the control functions can be assigned in software and optionally be user definable. Typically for example digit 4 may mean ‘rewind’ and digit 6 may mean ‘fast forward’.

Various inventive features are described which may be used separately or in combination. Many modifications may be made to the preferred system which is given by way of illustration only.

### BRIEF DESCRIPTION OF THE DRAWINGS

The invention will be described in more detail by way of example with reference to the accompanying drawings, in which:

FIG. 1 is a schematic diagram showing the components of a preferred system embodying the invention;

FIG. 2 is an outline flowchart (flowchart 0) setting out the stages in the operation of the system of FIG. 1 in accordance with this invention when the user of the WAP mobile telephone wishes to receive a real-time audio stream from the internet;

FIG. 3 is a diagram based on FIG. 1 showing the system in an initial condition in which the user of a WAP mobile telephone initiates a WAP session to access the internet;

FIG. 4 is a flowchart (flowchart 1) showing the steps involved in the first stage in which the system sends a request for the real-time streaming audio service to the audio proxy in the system of FIG. 1;

FIG. 5 is a diagram based on FIG. 1 showing the system when in stage 1 represented in FIG. 4;

FIG. 6 is a flowchart (flowchart 2) showing the steps involved in stage 2 of the operation, in which the audio proxy determines the location of the mobile telephone user and thus determines which audio gateway should be used;

FIG. 7 is a diagram based on FIG. 1 showing the system when in stage 2 represented in FIG. 6;

FIG. 8 is a flowchart (flowchart 3) showing the steps involved in stage 3 of the operation, in which the audio gateway determines a telephone number to be associated with the audio stream request;

FIG. 9 is a diagram based on FIG. 1 showing the system when in stage 3 represented in FIG. 8;

FIG. 10 is a flowchart (flowchart 4) showing the steps involved in stage 4 of the operation, in which the mobile telephone is instructed to call the assigned telephone number;

FIG. 11 is a diagram based on FIG. 1 showing the system when in stage 4 represented in FIG. 10;

FIG. 12 is a flowchart (flowchart 5) showing the steps involved in stage 5 of the operation, in which the audio gateway connects the user of the mobile telephone to the audio stream;

FIG. 13 is a diagram based on FIG. 1 showing the system when in stage 5 represented in FIG. 12;

FIG. 14 is a flowchart (flowchart 6) showing the steps involved in stage 6 of the operation, in which the audio streaming is taking place and the audio gateway monitors the link to locate any transport commands and to detect call termination;

FIG. 15 is a diagram based on FIG. 1 showing the system when in stage 6 represented in FIG. 14;

FIG. 16 is a flowchart (flowchart 7) showing the steps involved in stage 7 of the operation, in which the audio gateway terminates the real-time audio service for this call;

FIG. 17 is a diagram based on FIG. 1 showing the system when in stage 7 represented in FIG. 16;

FIG. 18 is a flowchart (flowchart 8) summarizing the software at the audio proxy in accordance with the preferred embodiment of this invention; and

FIG. 19 is a flowchart (flowchart 9) summarizing the software at the audio gateway in accordance with the preferred embodiment of this invention.

### DETAILED DESCRIPTION OF THE PREFERRED EMBODIMENT

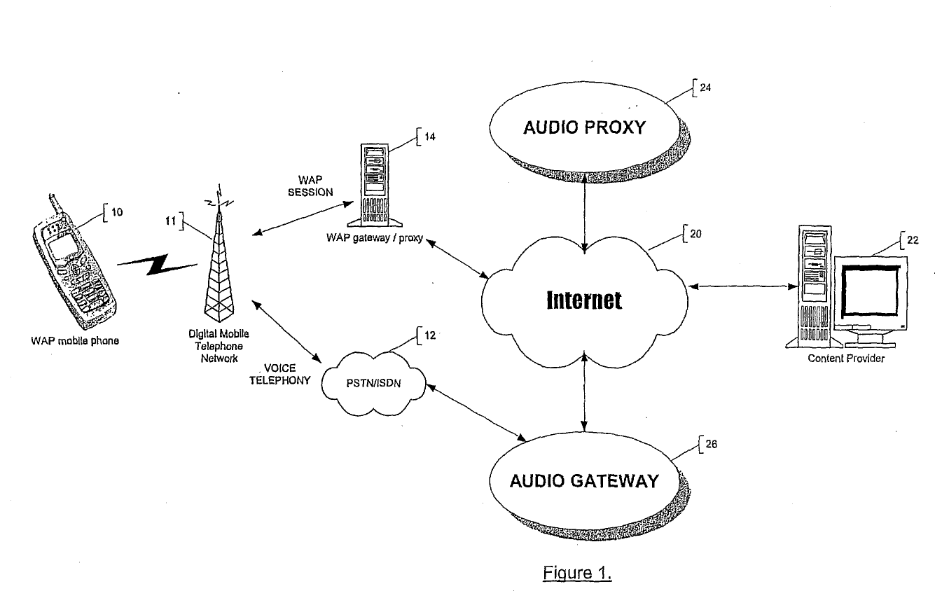

Referring first to FIG. 1, the components of the preferred system 10 embodying the invention are illustrated. The system is directed to providing the user of a mobile telephone 10 with a real-time audio stream containing information or entertainment. It may, for example, be financial or sports news, or it may comprise music tracks. For this purpose the mobile telephone can communicate for telephone purposes with the public switched telephone system 12 in conventional manner. In order to enable internet access, the mobile telephone can alternatively communicate with a WAP gateway 14, making use of WAP (Wireless Application Protocol) software loaded in the mobile telephone 10. The WAP software on the mobile telephone is known as a WAP client. The WAP gateway 14 is linked with the internet 20.

Also shown on FIG. 1 is one example of a content provider 22 which likewise is linked with the internet 20. Also linked with the internet 20 is an audio proxy 24 at a control location, and an audio gateway facility 26. The audio gateway further communicates by means of a voice telephony gateway included in the audio gateway with the public switched telephone network 12. It will be appreciated that where reference is made to the public switched telephone network (PSTN), it could be by means of ISDN lines. Briefly and in summary, when the user of the mobile telephone 10 wishes to listen to an audio stream, they initiate a WAP session via the WAP gateway 14 through the internet 20 to an appropriate content provider 22. The user of the mobile telephone 10 will see a display, typically showing a number of possible real-time audio streams that are available. The user then selects one of these audio streams as being the audio stream they wish to listen to.

In response to this, the content provider 22 refers the user's WAP client to the audio proxy 24, by means of an internet hyperlink. The audio proxy 24 is now responsible for the WAP dialogue or conversation with the mobile telephone, related to the delivery of the audio stream. The audio proxy is based on a commercially available internet connected computer, running a Web server and configured to communicate with WAP clients. The computer is programmed with software to control the WAP dialogue with the mobile telephone, and also communicates with the remote audio gateway 26 as will be described.

What the audio proxy 24 now does is to send to the mobile telephone information identifying a telephone number which it must call in order to access the real-time audio stream. This may also be supplemented with check digits as described below. On receipt of this information, the mobile telephone disconnects from the WAP session and now initiates communication over the normal mobile telephone channels with the public switched telephone network 12. That is to say, the mobile telephone automatically makes a voice call to the telephone number which has been communicated to it by the audio proxy 24. This telephone number is associated with the audio gateway 26. The audio gateway 26 converts the internet audio received from the content provider 22 over the internet 20 into a form deliverable to the PSTN (Public Switched Telephone Network). A suitable protocol for delivery to a telephony device is G.711 as specified by the International Telecommunications Union (ITU). The audio gateway 26 has associated with it a pool of telephone numbers available for use by such callers.

The audio gateway is formed of a commercially available voice telephony gateway which interfaces directly to the public telephony network 12. It also includes a computer programmed to convert from the real-time streaming internet audio received via the internet 20 from the content provider 22, and it includes a commercially available database which allows the audio gateway to manage the allocation and mapping of telephone numbers to audio streams, as described below. The database can also be used to log call activity.

Thus, FIG. 1 shows the overall sequence which enables the user of a WAP mobile telephone to use a real-time streaming audio service. As described, initially a WAP session is established. Through the WAP client on the mobile telephone, the user navigates textual and graphical information delivered by the remote content provider 22 via the internet 20 and WAP gateway 14. During this navigation phase, the user selects a link to an audio stream which they wish to hear. The user may then listen to the audio stream via the voice telephony capability of the mobile telephone. While listening, the user may control the audio stream using the telephone keypad, as described below, until the telephone call is terminated.

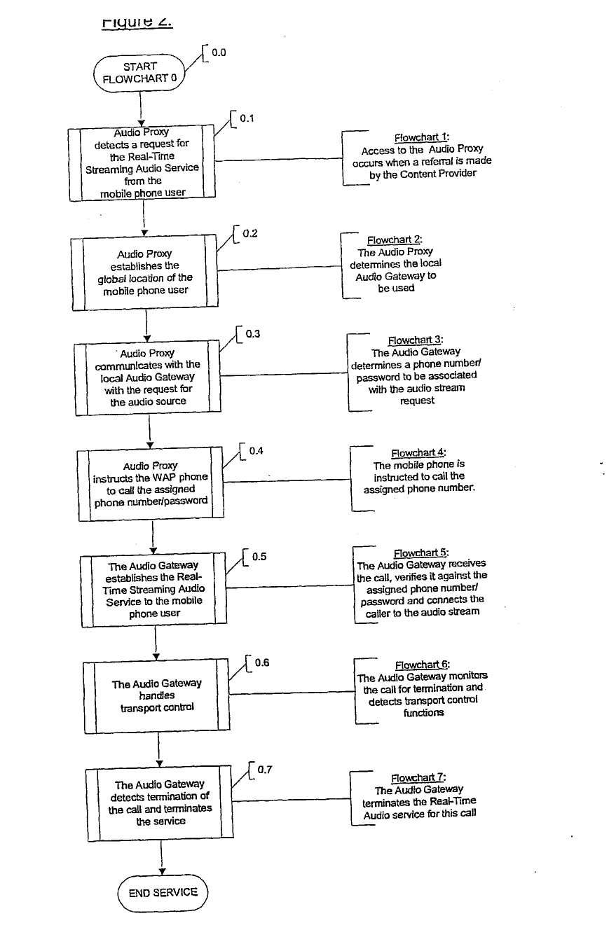

The stages involved in this operation are illustrated in the outline flowchart of FIG. 2. It is first assumed that a WAP session is taking place. During the course of this session the user makes a request for real-time audio. This starts the service as shown at block 0.0 in FIG. 2. The WML (Wireless Markup Language) document refers the mobile telephone to the audio proxy 24.

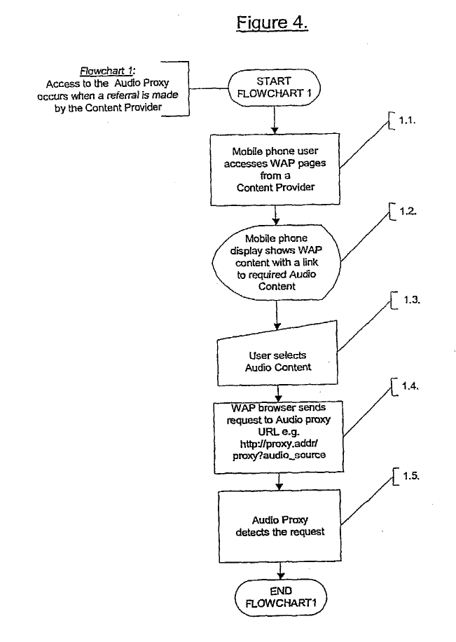

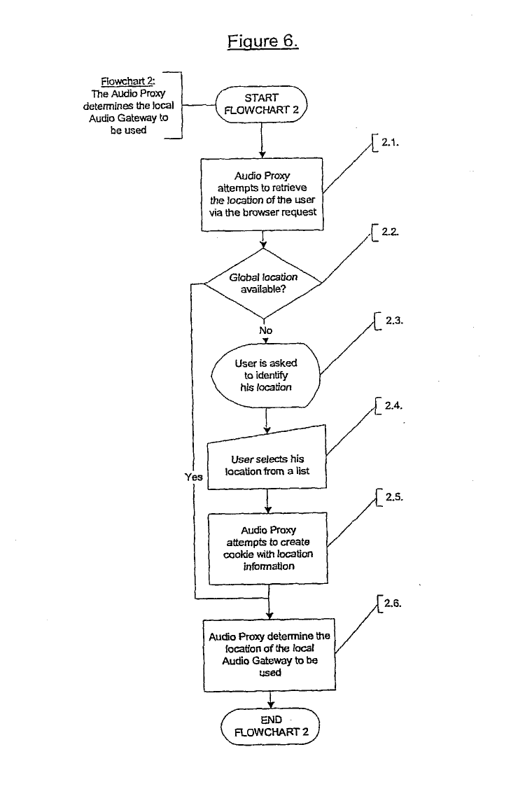

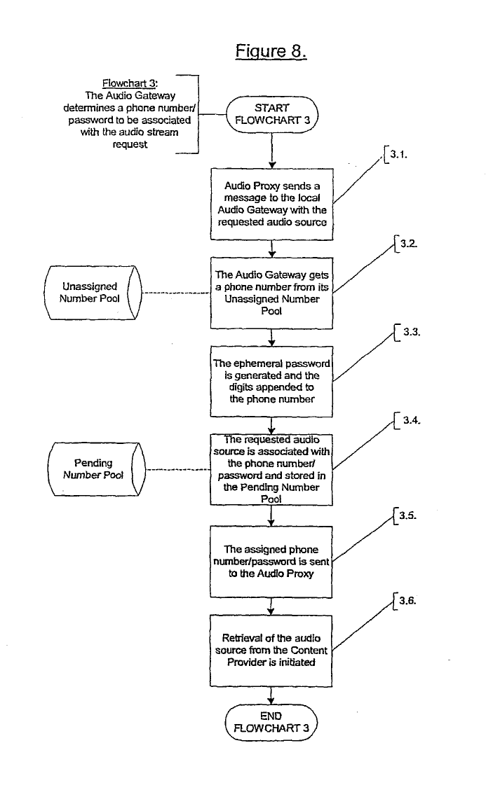

The next stage is for the audio proxy 24 to detect the request for the real-time streaming audio service from the mobile telephone user, step 0.1. This is set out in more detail in FIG. 4 as described below. After that, in stage 2, the audio proxy establishes the global location of the mobile telephone user, step 0.2. This is set out in more detail with reference to FIG. 6 of the drawings. In stage 3, following stage 2, the audio proxy 24 communicates with the local audio gateway 26 and transmits to it the request for the audio source, step 0.3. This is explained in more detail below with reference to FIG. 8.

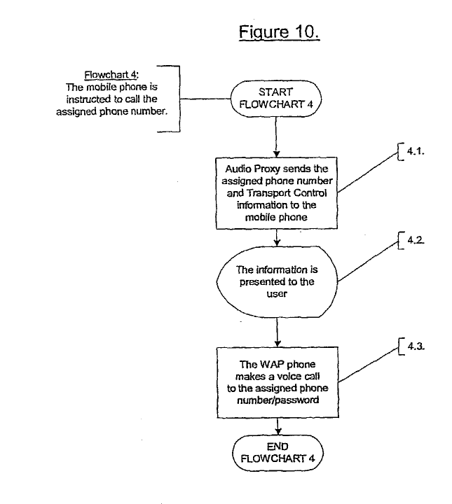

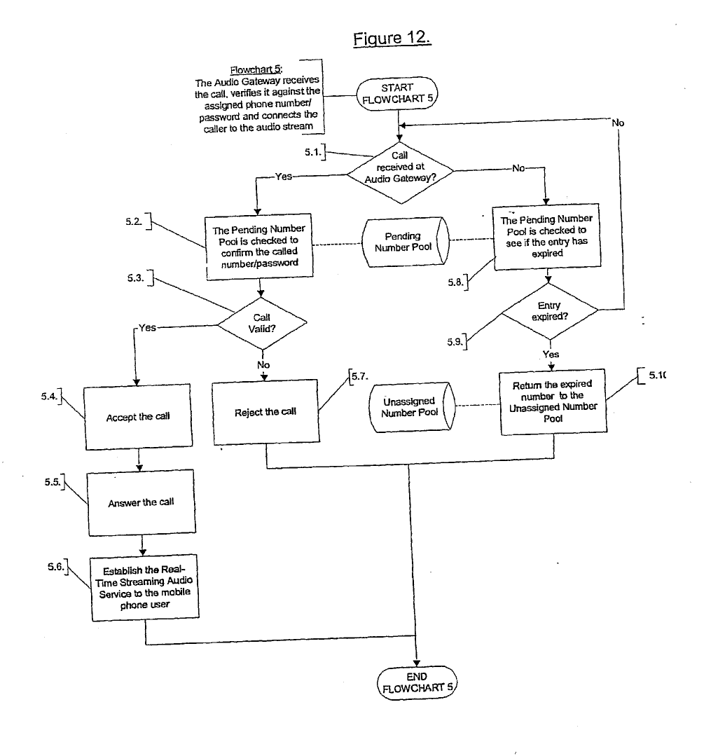

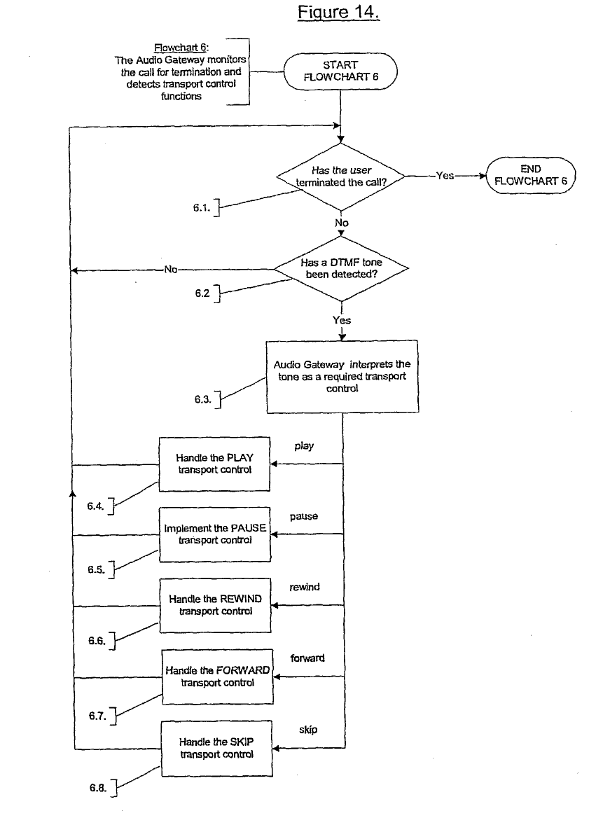

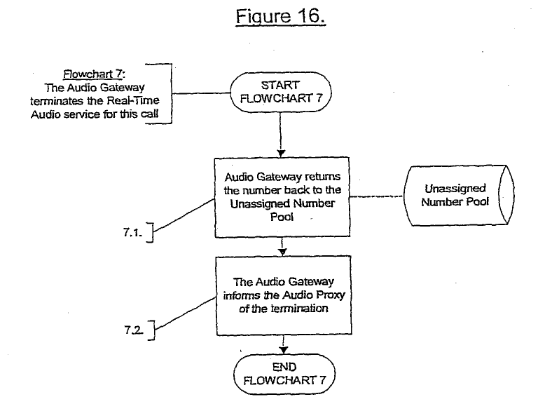

In the next stage, the audio proxy 24 then instructs the WAP telephone to call an assigned telephone number which it has obtained from the audio gateway 26, and to incorporate in the dialled digits a password, step 0.4. This is explained below in more detail with reference to FIG. 10. The audio gateway 26 then sets up communication over the internet 20 with the content provider 22, and provides a feed of the real-time streaming audio service to the mobile telephone user via the public switched telephone network 12, step 0.5. This is explained in more detail below with reference to FIG. 12. During the time that the streaming service is being supplied to the telephone user, the audio gateway is prepared to handle transport control, step 0.6. This is explained below in more detail with reference to FIG. 14. And finally, the audio gateway 26 also monitors, during the voice call, for termination of the call, and when the call is terminated, then terminates the service from the content provider, step 0.7. This final stage is described below with reference to FIG. 16.

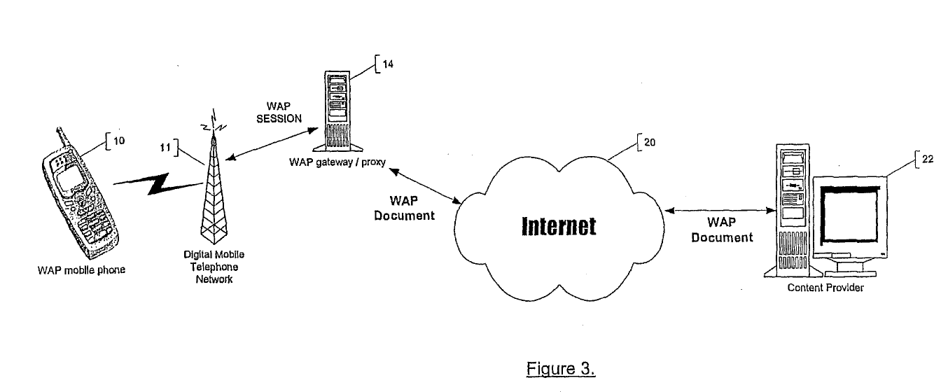

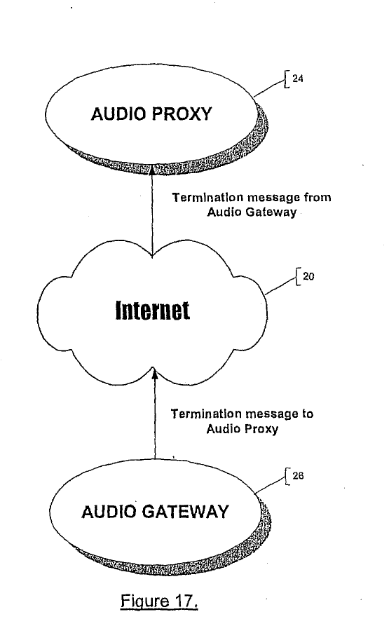

Now referring to FIGS. 3 to 17, the stages 1 to 7, which correspond to steps 0.1 to 0.7 on FIG. 2 and to flowcharts 1 to 7, will be described in more detail.

The assumed initial configuration is where the mobile telephone user 10 is in communication via the WAP gateway 14 and the internet 20 with the content provider 22, which provides WAP content to the mobile telephone. The user of the mobile telephone uses this content and, as shown in FIG. 4, navigates textual and graphical information delivered by the remote content provider, step 1.1. During this navigation phase, the user can be presented with an option to listen to an audio stream, step 1.2. The user then manually selects a desired link, step 1.3, corresponding to the particular real-time audio to which they wish to listen. The link as defined in the WML document instructs the WAP client to connect to a specified URL (Uniform Resource Locator). The URL contains the address of the audio proxy and, as a parameter, the audio source. The URL will therefore be in the form:

http://proxy.addr/proxy?audio_source

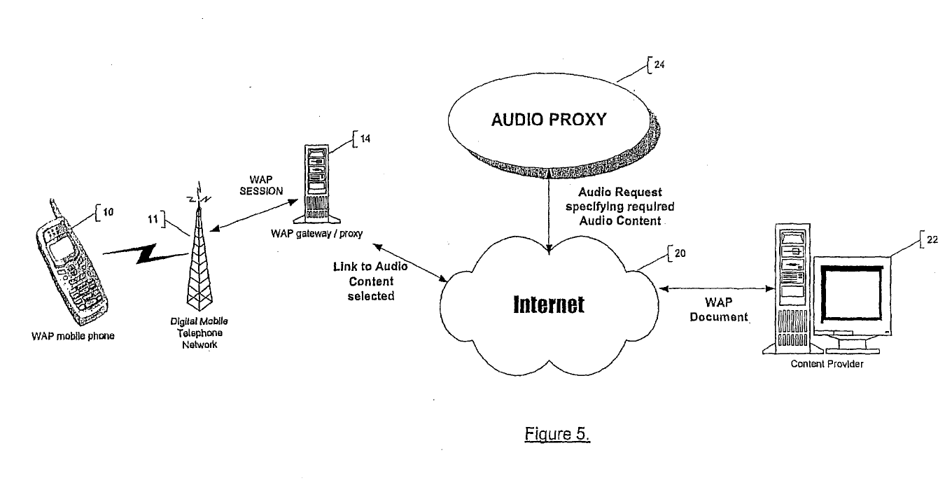

The audio proxy equipment 24 receives the request from the WAP telephone 10 via the internet 20, step 1.5. This completes the first stage of operation. This stage is diagrammatically illustrated in FIG. 5.

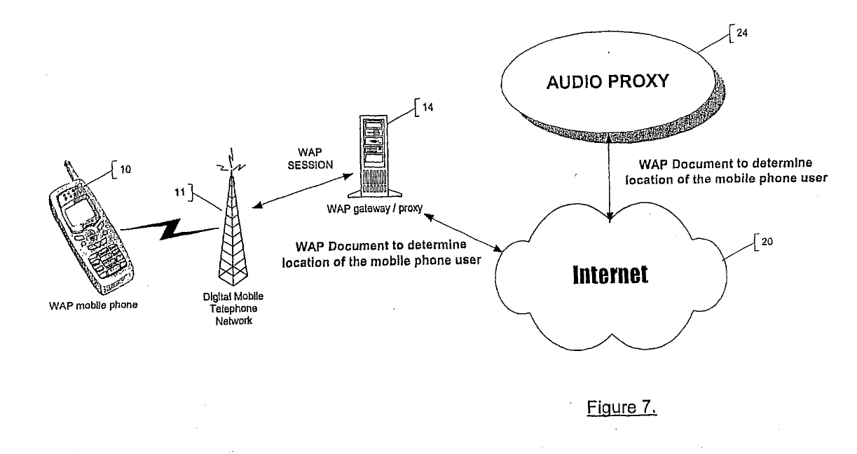

The process now moves to stage 2 illustrated in the flowchart of FIG. 6 corresponding to step 0.2 in FIG. 2. In this second stage, the audio proxy 24 determines the local audio gateway 26 which is to be used. There may be, and typically will be, more than one such audio gateway, at different global locations. Indeed the audio proxy 24 may receive requests from anywhere in the world, so it needs to be sure that the mobile telephone user is connected to the audio gateway which is closest to it. To achieve this, the system retrieves locality information about the mobile telephone, to the extent possible, step 2.1. The Audio Proxy attempts to retrieve a cookie from the WAP client on the mobile telephone 10, or alternatively from the WAP gateway/proxy 14. If this cookie exists it will have been created previously during a WAP session in which the WAP client was asked to state his geographical location. A cookie is a well known type of persistent storage mechanism. If this cookie is not available or does not contain the geographical location as required as determined at step 2.2, then further steps are undertaken. First of all, a WML document is sent to the mobile telephone 10 to present to the user a list of countries where audio gateways are available, step 2.3. The user selects their location from this list, step 2.4, and the audio proxy 24 then attempts to create a cookie for future reference, step 2.5, to avoid the need to go through this procedure again. Once the location of the user is known, the audio proxy determines the appropriate local gateway to be used for the real-time streaming audio, step 2.6. That then completes stage 2 of the operation. This stage is also illustrated in form similar to FIG. 1 in FIG. 7 of the drawings.

The procedure now moves to stage 3 illustrated in FIG. 8 by means of flowchart 3. In this stage the audio gateway determines a telephone number, optionally together with a password, to be associated with this audio stream request. First of all, the audio proxy 24 and the selected local audio gateway 26 communicate with each other via the internet 20. In fact, this communication could take place through any other signalling method such as through fixed lines or the public switched telephone network. Preferably, however, the communication is through the internet 20. In this procedure, the audio proxy 24 sends a message to the audio gateway 26 to request a telephone number. The audio proxy also informs the audio gateway of the internet address of the audio stream which has been requested by the particular mobile telephone user, step 3.1. That is, the audio proxy advises the audio gateway of the URL of the requested audio stream.

The audio gateway 26 has available to it a pool of telephone numbers which are held in an unassigned number pool. One of these telephone numbers is retrieved, step 3.2. The audio gateway then uses any suitable software algorithm to generate an associated password. The password generated is a string of digits which is unique to this particular session, and is also difficult for a third party to reconstruct, step 3.3.

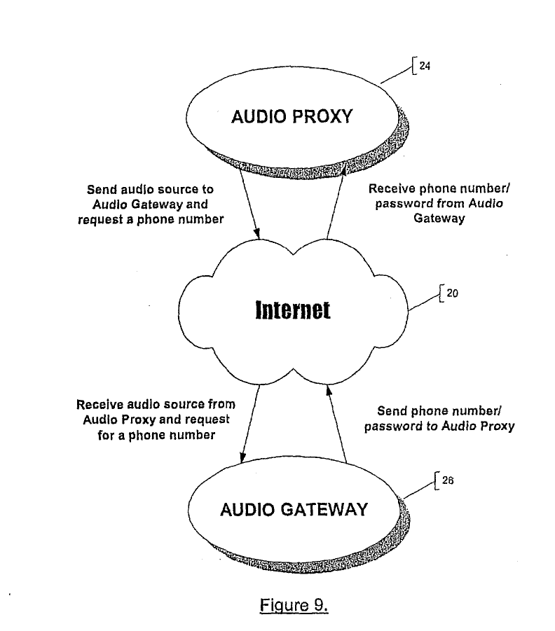

The telephone number and password, together with the address of the associated audio source (content provider), are then written at the audio gateway into a pending number pool, step 3.4, which will be used to verify incoming telephone calls as described below. At the same time the telephone number is removed from the unassigned number pool. A time-out is now initiated for this new entry, in order to return the pending telephone number to the unassigned pool if a call is not received within a specified time. Meanwhile, the assigned telephone number and password are sent back to the audio proxy via a secure connection across the internet, step 3.5, or using one of the other methods described above. A secure connection across the internet can be created using a standard protocol such as SSL (Secure Sockets Layer). The audio gateway also uses the associated internet address of the requested audio steam, to initiate a communication with the relevant content provider 22 and initiate retrieval of the audio stream from the content provider, step 3.6. This completes stage 3 of the procedure. This stage is also illustrated diagrammatically in FIG. 9.

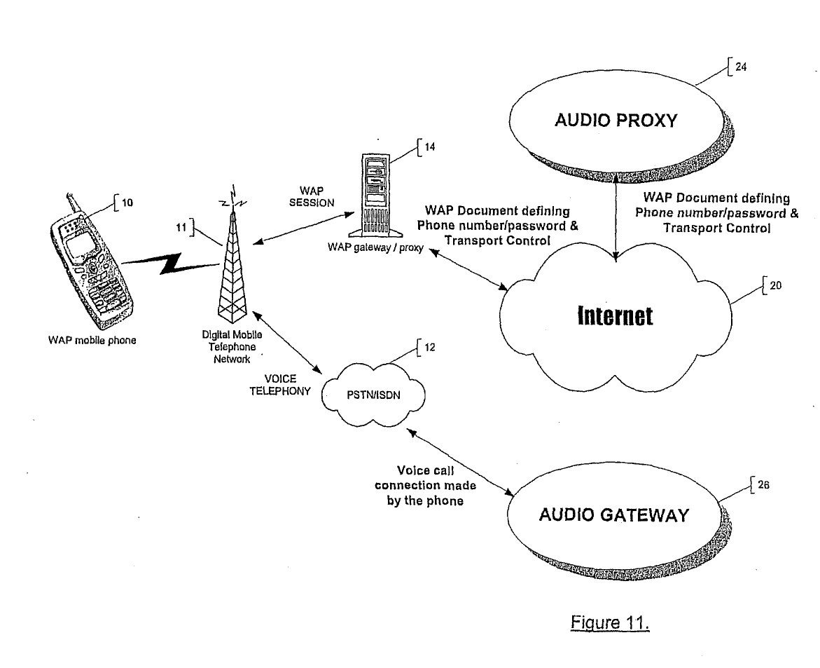

Stage 4 of the procedure is now initiated. This is illustrated in FIG. 10, which shows the initiation of a telephone call from the mobile telephone 10 to the local audio gateway 26. On receipt of the assigned telephone number and password, in stage 3 above, the audio proxy 24 responds to the original request from the mobile telephone as follows. First of all, the audio proxy sends a WML document to the WAP client, step 4.1. This WML document is a software program which contains a screenful of instructions for the end user about the use of transport controls during the audio session. This is presented to the user in step 4.2. The WML document also contains the assigned telephone number and password. Within the WML document is a WTAI (Wireless Telephony Applications Interface) Make Call function that instructs the mobile telephone to automatically initiate a voice telephony call, using the programmed combined telephone and password number string, step 4.3. The telephone may prompt the user to acknowledge this step. That is to say, the mobile telephone dials the telephone number and adds to the dialled telephone number the digits forming the password string. These password digits are simply transmitted through the cellular telephone and PSTN network to the audio gateway in exactly the same manner as the dial digits. This completes stage 4 of the operation which is diagrammatically illustrated in FIG. 11.

Now the procedure moves to stage 5 which is illustrated in flowchart 5 forming FIG. 12. In this stage the audio gateway receives the call, verifies it against the assigned telephone number and password combination, and connects the caller to the required audio stream. The flowchart shown in FIG. 7 starts at the stage at which the audio gateway 26 is expecting to receive a telephone call from the mobile telephone 10. At this stage, as will be seen from the foregoing, the mobile telephone display will be prompting the user to proceed, and thus instigate the telephone call. Meanwhile, the audio gateway 26 has a time-out in progress on the assigned number in the pending number pool.

In step 5.1 a determination is made as to whether a telephone call is received at the audio gateway. If the answer is ‘yes’ and a call is received, the called number and password are extracted from the voice telephony gateway forming part of the audio gateway 26. The entry in the pending number pool located at the audio gateway is now checked against the called number extracted from the received telephone call, step 5.2. Likewise, the password received as part of the telephone call is checked against the password stored against that assigned telephone number in the pending number pool. If the assigned telephone number and the password match, the call is regarded as valid and accepted, step 5.4, and answered step 5.5. Now the real-time streaming audio service is started step 5.6. That is to say, the audio gateway 26 retrieves the real-time audio from the content provider 22 via the internet 20, and transmits it via the PSTN 12 as part of the voice telephony call to the mobile telephone 10. At this point the user thus hears the requested internet audio stream. The audio gateway currently streams internet audio from the content provider over the internet and converts it into a format suitable to interface to the voice telephony gateway in the audio gateway 26.

If a call is received at the audio gateway, but is not verified at step 5.3, either because there is no entry in the pending number pool, or because the entry does not match an extracted telephone number and password combination in step 5.2, the call is flagged as not valid. The call may simply be rejected, step 5.7, or alternatively can be answered and an announcement issued indicating that the dialled telephone number was incorrect.

All the time that the audio gateway 26 is awaiting a call, and no call has been received and detected at step 5.1, the entry in the pending number pool is checked, step 5.8, to determine if the timeout which was initiated when the number was assigned has expired. If it has expired, step 5.9, the telephone number session is deemed to have failed and the number is returned to the unassigned number pool, step 5.10.

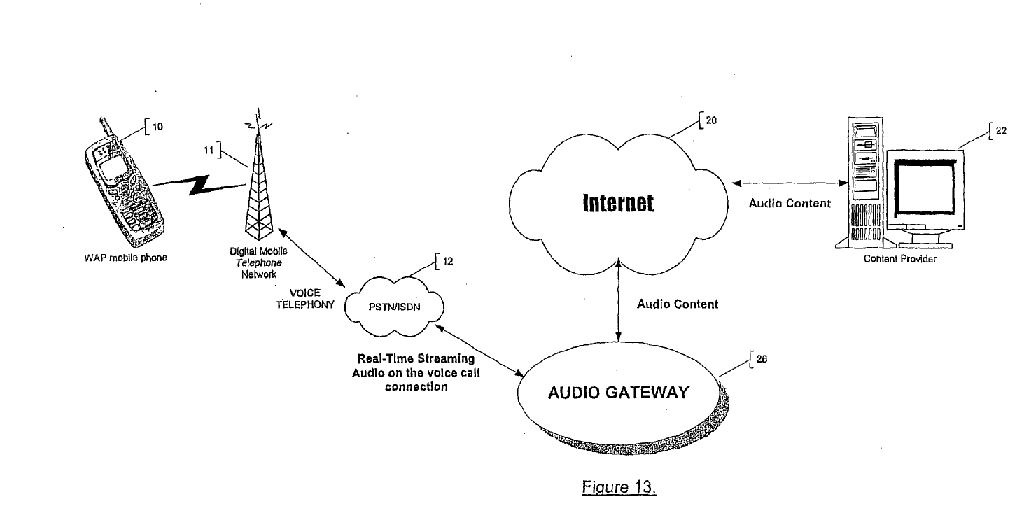

This now completes stage 5 of the operation which may continue so long as the user of the mobile telephone is happy to continue listening to the real-time audio stream. Stage 5 is illustrated in diagrammatic form, similar to FIG. 1, in FIG. 13.

During this time, stage 6 of the procedure is in effect. This is illustrated in flowchart 6 forming FIG. 14. In this state the audio gateway 26 monitors the telephone line for termination of the call, and also monitors the telephone line for possible transport control functions. Dealing first with termination, the call is deemed as terminated if the user ends the call at the mobile telephone, or, for any reasons, the line goes down, step 6.1.

So long as the line remains connected however, the audio gateway monitors the telephone line for possible DTMF tones, from the keypad of the mobile telephone 10, step 6.2. These tones are generated when the user presses any button on the mobile telephone keypad. Some of the specific keys are assigned to particular transport control functions, as has been presented previously to the user on the mobile telephone display when in the WAP session. The audio gateway interprets the detected DTMF tones which it interprets as requiring a transport control function to be effected, step 6.3, and performs the appropriate action as follows:—

If a PLAY transport control is identified (e.g. digit 2), the audio gateway initiates or continues the audio stream to the mobile telephone, step 6.4.;

If a PAUSE transport control is identified (e.g. digit 5), the audio gateway implements pause transport control and interrupts the audio stream to the mobile telephone, step 6.5;

If the audio gateway identifies a REWIND transport control signal (e.g. digit 4), it “rewinds” the audio stream to a previous point, step 6.6. The term “rewind” is used by analogy to the rewind function on a tape player.

If a FAST FORWARD transport control command (e.g. digit 6) is identified by the audio gateway, it fast-forwards the audio stream to a later point, step 6.7.

If a SKIP transport control is identified (e.g. digit 0), the audio gateway moves onto the next item in the audio stream, step 6.8, this being, for example, analogous to the next track on a CD.

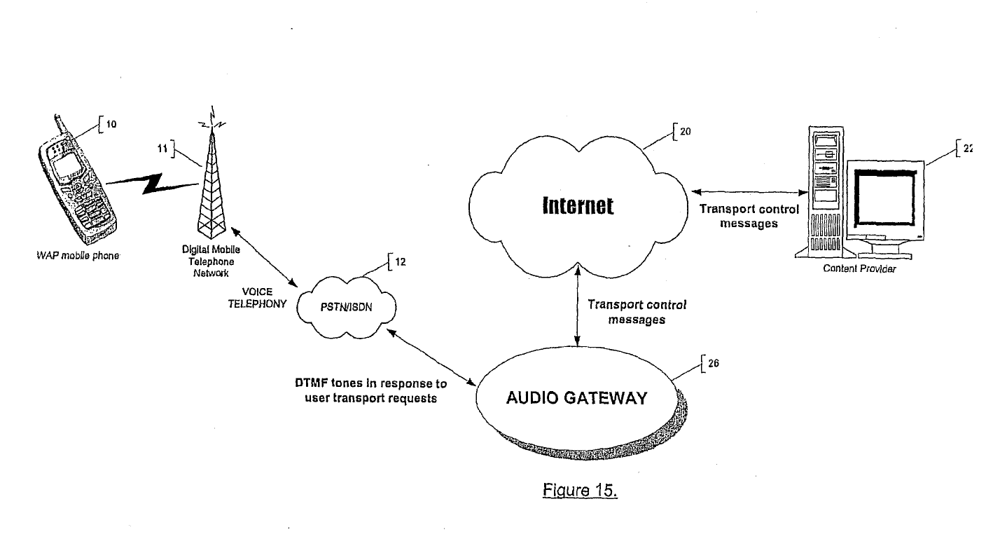

Stage 6 as illustrated in FIG. 14 is also shown diagrammatically in FIG. 15.

The final stage, stage 7, is shown in FIG. 16 and is the stage in which the audio gateway terminates the real-time audio service for this call. Upon termination following a ‘yes’ decision at step 6.1 in FIG. 14, the assigned telephone number is now returned to the unassigned number pool, step 7.1, for subsequent re-use. The audio gateway 26 then communicates with the audio proxy to inform the equipment of termination, step 7.2, so that the audio proxy can update its database of system activity. Naturally at the same time the audio gateway ceases the real-time audio feed via the internet 20 from the content provider 22. Optionally, information relating to the session statistics can be sent back to the content provider.

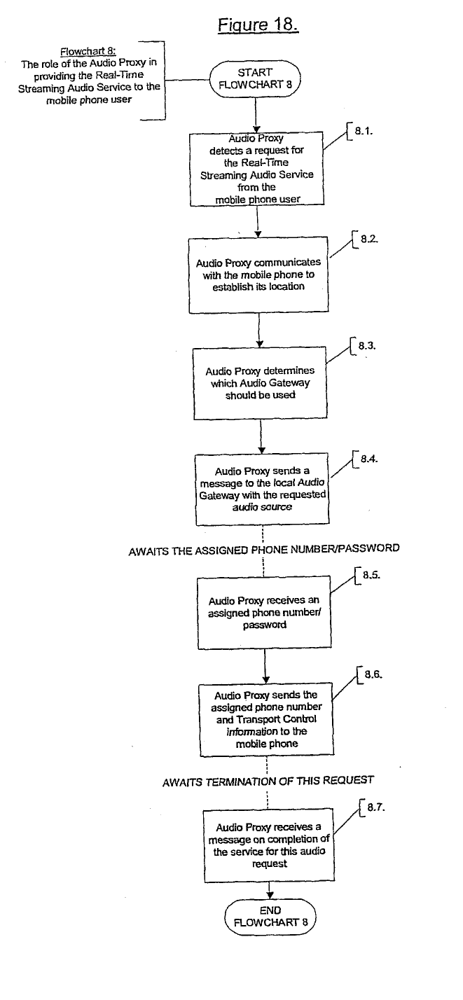

FIG. 18 is a flowchart, flowchart 8, which is based on the above description and summarizes the steps which are undertaken at the audio proxy, during an operation of providing real-time streaming audio service to a mobile telephone user. The steps set out in FIG. 18 correspond to steps described above, but are conveniently collected together in one figure for ease of description of the functions of the audio proxy. First, the audio proxy detects a request for real-time streaming audio from a mobile telephone user, step 8.1. In response to this the audio proxy communicates with the mobile telephone to establish its location, step 8.2. Dependent upon the location of the mobile telephone terminal, the audio proxy selects an audio gateway for use, step 8.3, this normally being the audio gateway to which the mobile telephone is geographically closest. The audio proxy then sends a message to the selected audio gateway with details of the audio source which has been requested by the mobile telephone, step 8.4. The audio proxy is now quiescent, until it receives an assigned telephone number and password from the audio gateway, step 8.5. The audio proxy then sends this assigned telephone number, together with appropriate transport control information, to the mobile telephone over the internet, step 8.6. The contribution of the audio proxy to the setting up of the audio streaming service requested by the mobile telephone user is now complete, and the audio proxy simply awaits termination of the audio stream. On completion of the service for the current audio request, the audio proxy will receive a completion message, step 8.7, and will complete the steps in the flowchart 8 of FIG. 18.

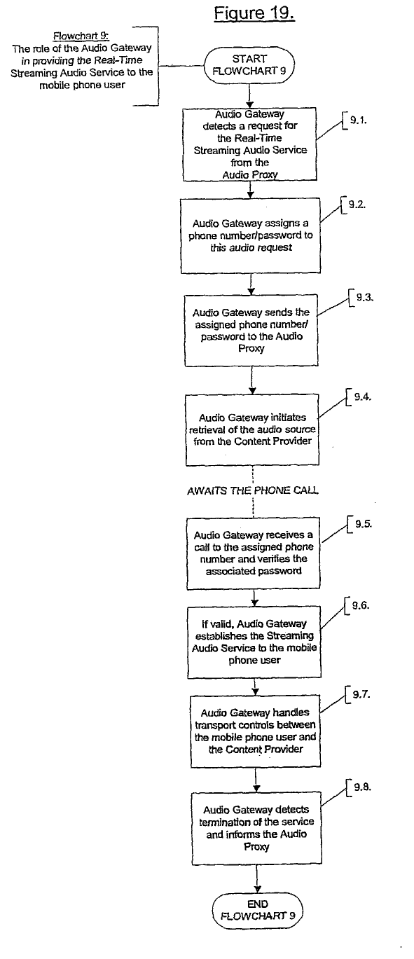

FIG. 19 similarly, and on the basis of the description given above, collects together the steps which are undertaken at the audio gateway. As seen in FIG. 19, initially the audio gateway detects a request from a telephone terminal user for an audio stream, step 9.1. This request comes via the audio proxy. In response to this the audio gateway assigns a telephone number and password to the audio request, step 9.2, and transmits the assigned telephone number and password to the audio proxy, step 9.3. Conveniently at that point, the audio gateway initiates retrieval of the audio stream from the audio source or content provider, step 9.4.

The audio gateway now awaits the reception of a telephone call on the assigned telephone number, and on receipt of such a call verifies the associated password which has been transmitted along with the dialled digits, step 9.5. If the password is valid, the audio gateway now establishes the streaming audio service, which was initiated at step 9.4, to the mobile telephone user, step 9.6.

The audio stream now continues and while the streaming service is being provided to the mobile telephone user, the audio gateway can receive and handle transport controls from the mobile telephone user and transmit them to the content provider or audio stream source, step 9.7. Eventually, completion of the audio steam service is detected by the audio gateway. The audio gateway informs the audio proxy, step 9.8, and terminates the communication with the audio stream source and with the mobile telephone.

Various possible modifications can be made to the system described above. For example, each mobile telephone user may have their own dedicated telephone number and/or dedicated system, which they telephone in order to listen to internet audio which they select. By giving each mobile telephone user their own telephone number, this replaces the need for telephone number pools, and ephemeral allocation of telephone numbers, but requires a greater total number of telephone numbers to be used, particularly if many of the mobile telephone users use the system only infrequently.

In another alternative possibility, the mobile telephone user may be requested to dial the assigned number manually, rather than the WAP telephone directly dialling the assigned number using the WML “WTAI” command.

Although it is preferred to use the appended password digit string as part of the telephone number, in the manner described above, this is, in principle, not essential to the operation of the system and need not be used if a lower level of security is acceptable.

Additional security techniques can be applied, either in addition to or as a substitute for the appended password digit string approach. Firstly, when the call is first received, the user can be required to enter a PIN code using the telephone keyboard, in turn generating DTMF tones which can be detected and verified by the audio gateway. The PIN code can be semi-permanently assigned to, or defined by the user for use on multiple occasions, or alternatively be generated for the current session only and presented to the user during the WAP stage. Alternatively, instead of the user being required to enter the PIN code, it could be included in the instruction to the mobile telephone to establish the call. By using pause commands in the dial string, the telephone dials the number of the audio gateway, waits for a short period (which coincides with the time delay before the audio gateway has answered the call) and then the telephone automatically sends the PIN code as DTMF tones to the audio gateway.

Similarly, another approach is to use the WTAI command to “Add Phonebook Entry” to the phonebook of the mobile telephone, containing the dial string, including the pause and PIN code. The user is then instructed to dial the corresponding phonebook entry.

An alternative to the user-entered PIN code is the use of a spoken password. In this scenario, after the call is accepted by the audio gateway, the user is required to speak a password. A readily-available software program can be used to verify if the spoken word matches the password stored in the database. Finally, the A-number (that is the telephone number of the mobile telephone) can be detected by the audio gateway and used to authenticate the incoming call against the number held in the database. The number held in the database must have been stored during the WAP session, in which the user was either asked to enter the mobile number, or alternatively the information had previously been obtained by retrieving it from a cookie. Another possibility for obtaining the A-number during the WAP session would be to interrogate the WAP gateway which may be able to determine this directly from the mobile telephone.

Another alternative to using an assigned telephone number pool arises if multiple connections can be established on the same telephone number. With this arrangement, once the call has been accepted by the audio gateway 26, the number is placed back into the unassigned pool, rather than the assigned pool. The next request can then re-use this same telephone number prior to the termination of the existing telephone connection.

An alternative to the content provider (the audio stream source) referring the WAP client to initiate a WAP session with the audio proxy, is for the content provider to communicate directly with the audio proxy, and for all WAP communications to be channelled through the content provider. This can be achieved using JAVA servlets and JAVA RMI (Remote Method Invocation). This removes the need for the WAP client to communicate directly with the audio proxy.

While the audio proxy and audio gateway have been described as being at different locations, it would be possible for them to be at the same location. In another arrangement, the audio proxy could actually be at the content provider site.

Finally, the geographical location of the mobile telephone could be identified by interrogating or receiving it directly from the WAP client, the mobile network, or the WAP gateway/proxy. This represents a possible alternative to either communication with the user via the telephone display, or the persistent storage or ‘cookie’ method.

Another approach is to derive the geographical location of the mobile telephone by detecting the address of the WAP gateway/proxy it is using. If the location of the WAP gateway/proxy is well-known, then an assumption could be made that the country location of the mobile telephone is the same. This technique fails if the mobile telephone is roaming outside of its home country or it is using a WAP gateway/proxy located physically in a separate country.

While the system has been described above as relating to the internet, it is also suitable for use for other networks, for example an Intranet.

Whilst reference has been frequently made to a mobile telephone, it is anticipated that future devices capable of making voice calls via a wireless network will not necessarily be labelled as such. That is, what is described above as a telephone terminal may be implemented as a device which has a telephone function in addition to other functions. The same methodology can be employed for delivering Internet audio to these future devices.

Methods similar to those described above for a WAP mobile telephone could also be used with other browser technologies designed for mobile telephones, for example HDML (Handheld Device Markup Language). In addition, the system could be adapted for use with older mobile telephones, such as those supporting the standard GSM (Grand System Mobile) interactive text features like SMS (Short Message Service) and USSD (Unstructured Supplementary Services Data). In this case, instead of a WAP session being used to select the required audio stream, the user selects it by sending an SMS or a USSD string. The audio proxy 24 responds via SMS or USSD to the mobile telephone with the required telephone number to be dialled.

In an alternative modification, it is possible to connect many mobile telephones to one audio stream. This would be particularly relevant for example in delivering audio for a live sporting event. The system described above is somewhat inefficient, in that the audio gateway would be required to establish multiple connections to the remote content provider for the same audio stream. To avoid this, an enhanced audio gateway connects the first caller as described above, but for a second caller requiring the same audio stream, the audio gateway identifies that the request is for the same stream and that the stream is a live feed. The audio gateway then connects the second caller and any subsequent callers to the same stream locally, without needing to establish additional connections across the internet.

Further Modifications

It has been described in detail above how telephone numbers on the audio gateway 26 are allocated to represent audio stream source URLs for a temporary period (i.e. long enough for the user to have connected to and listened to the service). It may be desired, however, either by the user or the content provider, that the audio service is available indefinitely, and reachable via a fixed (i.e. constant) phone number which could be stored in the phone book of the mobile phone (or that of the SIM card it contains) for easy retrieval.

Fixed number representation of audio services may be generally available, i.e. the same number can be used by multiple users to access the same service; or it can be assigned to a specific user which requires that the audio gateway is also able to detect and identify that user when they connect. The user could be identified from the calling (subscriber) number string or by asking the user to enter a digit string, or speak a password that is unique to them.

The content provider 22 can create a generally available fixed number by requesting it from the audio proxy 24. For example, the content provider can use a Web based interface to login to the audio proxy and then request an allocation from the fixed number pool and provide the audio stream source URL details it is to be associated with.

The same audio service can be provided no matter who is calling the number or when it is called, or alternatively the specific audio stream can be customised or personalised to suit. Thus, if a user dials the fixed number, the audio gateway attempts to retrieve the audio stream from the assigned source URL. The audio gateway modifies the URL so that the user is also identifiable by the content provider (e.g. subscriber number is passed as a parameter on the URL call). With this capability the content provider can, as an example, advertise a soccer news service available by dialling “12345”. A generic stream is available which the content provider delivers if it cannot identify the user. It can, however, create individualised streams if it recognises the user and has a profile already stored. In this example, the served audio stream may only include news items relating to the teams that the user has expressed an interest in.

In the case where the content provider has not created a generally available fixed number, the user may request a fixed number allocation for his specific use. Such a request can take place during an audio session established via a temporary number, where the user can press a key combination (or give a spoken command) to initiate the request for the current audio service to be made available by a fixed number. Alternatively the user can make the request during a Web or a WAP session. Either way, the audio gateway is passed the user's phone number and the URL of the audio source. It then assigns a number from the user specific fixed number pool.

Once the number has been allocated from the pool, the user can be presented with it in a number of ways. This can be via a visual display in the Web or WAP session, or the number can be read out to the user in the audio session case. Alternatively in all cases, a short message can be sent to the telephone, using the short message service (SMS), with the allocated number embedded. This can instead be a message formatted as a new phone book entry so that the handset automatically recognises that it is a number to be stored in the phone with a provided label (e.g. phone number 12345, stored as “Soccer News”). One such standard for formatting messages in this way is Nokia's Smart Messaging Specification (the Business Card, or vCard component). In the case where the user requests a fixed number during a WAP session, the Public WTAI command “addPBEntry”, as specified in the WAP specifications, can also be used as an alternative to the Smart Messaging approach.

When a call is made to a user specific fixed number, both the called number and the calling (subscriber) number are used by the audio gateway to find the matching audio source URL.

In a situation where a user connected to the Internet via a non-mobile device (e.g. PC or set-top box) chooses an audio stream but is either unable to listen to the stream (e.g. perhaps due to a lack of multimedia features on the device) or would prefer not to be tethered to the device, we have appreciated that a solution would be desirable that allows the audio stream to be transferred to the user's mobile telephone. The solution can involve a button, either on the Web page, the browser, or on the audio client software, that the user presses to indicate his desire to transfer the audio stream to his mobile phone. The content provider or the end-user then provides the audio proxy with the URL for the required audio stream, and in return receives a temporary telephone number which will be displayed to the user in the browser or other client software. The user then manually dials the number from a fixed or mobile telephone.

It is possible that an audio stream is terminated prematurely, perhaps due to the user choosing to end the call, or due to a technical problem, such as a loss of signal on the mobile phone when driving through a tunnel. It may be desirable under such circumstances for the user to resume the stream; that is, for pre-recorded audio streams, that they can be restarted from the position reached at the point the call was terminated. For live audio streams a resume should, on the other hand, connect the user to the current position in the stream at the time the user initiates the resume.

Preferably, therefore, the system has the capability to resume audio streams. The user can initiate this by either re-dialling the voice call or by re-selecting the stream from the WAP page. If a resume is to be possible by means of re-dialling, then it is necessary for the audio gateway to maintain the context following the call termination. This can be achieved by creating a record in the audio gateway at the point of termination. The record stores the called number, calling (subscriber) number, the audio stream URL, and the position reached in the audio stream (this includes the item on the play-list and/or time from start of stream).

Future inbound calls to the audio gateway are checked to see if the called and calling numbers match any of these records. If a match occurs, then the URL and time position information can be used to resume the stream from the position it was previously left by that user. This technique does not restrict the availability of numbers on the audio gateway for normal allocation as both called and calling numbers must be detectable and matching a resume record, if a resume is to successfully take place.

As noted above, the mobile phone initiates contact with the audio proxy through an HTTP request with a destination address containing the proxy's URL and, as a parameter include in that request, the URL of the audio stream. One potential limitation of this technique is that the total URL length (number of characters) could exceed the maximum allowed by the phone and/or WAP gateway.

To overcome this limitation the audio stream part of the URL can be replaced by two tokens. One of these tokens is an identifier that the audio proxy recognises and can expand into a partial URL (this would typically point to a directory on the content provider's server). The second token is a string generated by the content provider, which is then appended to the partial URL. Collectively this creates the URL that the audio gateway will request the audio stream from. The content provider either serves the audio stream directly from this address or creates a referral to the real stream address.

Other modifications may be made to the system described and illustrated. Various features of the system described and illustrated and described as used in combination can be used separately from each other in connection with other systems.

1. A method of transmitting an audio stream to a telephone terminal, comprising the steps of:
establishing telephone communication between the telephone terminal and an audio gateway;
establishing communication via a computer network between the audio gateway and an audio stream source; and
transmitting the audio stream from the audio stream source via the computer network communication to the audio gateway and thence via the telephone communication to the telephone terminal.

2. A method according to claim 1, in which the step of establishing telephone communication comprises:
referring the telephone terminal to an audio proxy;
advising the telephone terminal of a temporarily-assigned telephone number to be called; and
calling that telephone number from the telephone terminal.

3. A method according to claim 2, further comprising, on conclusion of the telephone communication, un-assigning the assigned telephone number.

4. A method according to claim 1, in which the telephone terminal comprises a mobile telephone.

5. A method according to claim 4, further comprising the steps of determining the geographical location of the mobile telephone and in dependence thereon selecting for use one of a plurality of geographically-spaced audio gateways.

6. A method according to claim 1, in which, during receipt of the audio stream, depression of the telephone keypad causes control functions to be transmitted to the audio source to control the audio stream generated by the audio source.

7. A method according to claim 1, further comprising the step of initially sending a message to the audio stream source identifying that a specified telephone terminal user wishes to receive the audio stream from that source.

8. A method according to claim 7, in which the step of sending a message comprises sending a message from a telephone terminal.

9. A method according to claim 8, in which the step of sending a message comprises sending a message from the telephone terminal over the computer network.

10. A method of establishing telephone communication with a telephone terminal provided with a computer network browsing facility, comprising the steps of:
establishing computer network communication from a central location with the telephone terminal;
detecting through the computer network communication that the telephone terminal user requires access through the telephone network with a required facility;
temporarily assigning a telephone number for the communication between the telephone terminal and the facility; and
calling the assigned telephone number from the telephone terminal to establish telephone communication with the facility.

11. A method according to claim 10, in which the control location and the facility are at separate locations and communicate via the computer network.

12. A method according to claim 10, in which on conclusion of the telephone communication the assigned telephone number is un-assigned.

13. A method according to claim 10, in which there is a pool of telephone numbers available for assignment.

14. A method according to claim 10, in which if the assigned number is not called within a predetermined time, then the assigned number is un-assigned.

15. A method according to claim 10, in which the telephone terminal comprises a mobile telephone.

16. A method of making a secure telephone call from a first terminal to a second terminal over a telephone network, comprising the steps of:
advising the first terminal and the second terminal of a number password;
calling the second terminal from the first terminal over the telephone network by generating a dial string at the first terminal which consists of the telephone number of the second terminal immediately followed by the password;
transmitting the whole dial string over the telephone network as a unitary dial string; and
at the second terminal, when a call is received, determining whether the appended password matches the password advised to the second terminal, and if not refusing the call.

17. A method of receiving an audio stream from an audio source at a mobile telephone, in which the audio stream is transmitted at least in part over the internet, and during the receipt of the audio stream, depression of the mobile telephone keypad causes control functions to be transmitted through the internet to the audio source to control the audio stream generated by the audio source.

18. Apparatus for transmitting an audio stream to a telephone terminal, comprising:
a computer network;
an audio stream source connected to the computer network;
a telephone network;
a telephone terminal capable of being selectively connected to the telephone network and to the computer network;
an audio gateway connected both to the computer network and to the telephone network;
means for establishing communication over the telephone network between the telephone terminal and the audio gateway;
means for establishing communication via the computer network between the audio gateway and the audio stream source; and
means for transmitting the audio stream from the audio stream source via the computer network to the audio gateway and thence via the telephone network to the telephone terminal.

19. Apparatus according to claim 18, in which the telephone terminal comprises a mobile telephone.

20. Apparatus according to claim 18, further comprising an audio proxy, and means for referring the telephone terminal to the audio proxy, for advising the telephone terminal of a temporarily-assigned telephone number to be called, and for calling that telephone number from the telephone terminal.

21. Apparatus according to claim 18, further comprising means for sending a message to the audio stream source identifying that the telephone terminal user wishes to receive the audio stream from that source;

22. Apparatus according to claim 21, in which the means for sending a message is located at the telephone terminal.

23. An audio proxy for use in transmitting an audio stream to a telephone terminal, the audio proxy comprising:
means for detecting a request for an audio stream from a telephone terminal user and responsive thereto for sending a message to an audio gateway with details of the requested audio source;
means for receiving an assigned telephone number and transmitting the assigned telephone number to the telephone terminal; and
means for receiving a message on completion of the service for the audio stream.

24. An audio proxy according to claim 23, further comprising means operative on receipt of a request for an audio stream to communicate with the telephone terminal to establish its location and in dependence thereon to select an audio gateway for use.

25. An audio gateway for use in transmitting an audio stream to a telephone terminal, the audio gateway comprising:
means for detecting a request from a telephone terminal user for an audio stream;
means responsive thereto for assigning a telephone number from a telephone number pool to this request;
means for transmitting the telephone number;
means for receiving a telephone call on the assigned telephone number and responsive thereto for establishing communication with an audio stream source over a computer network such that the audio stream is passed to the telephone terminal; and
detecting completion of the audio stream service and terminating the communication.

26. Apparatus for establishing telephone communication with a telephone terminal, comprising:
a telephone terminal provided with a computer network browsing facility;
means for establishing communication via a computer network between a control location and the telephone terminal;
means for detecting through the computer network communication that the telephone terminal user requires access through the telephone network with a required facility;
means for temporarily assigning a telephone number for the communication between the telephone terminal and the facility; and
means for calling the assigned telephone number from the telephone terminal to establish telephone communication with the facility.

27. Apparatus for receiving an audio stream from an audio source at a mobile telephone, in which the audio stream is transmitted at least in part over the internet, and in which, during receipt of the audio steam, depression of the mobile telephone keypad causes control functions to be transmitted through the internet to control the audio stream generated by the audio source.
